(19) United States
(12) Patent Application Publication
(10) Pub. No.: US 2012/0136599 A1
(43) Pub. Date: May 31, 2012

(54) WIRE VERIFICATION METHOD, WIRE VERIFICATION APPARATUS AND WIRE VERIFICATION PROGRAM FOR SEMICONDUCTOR INTEGRATED CIRCUIT

(76) Inventor: SHIGETO INUI, Tokyo (JP)

(21) Appl. No.: 13/223,827

(22) Filed: Sep. 1, 2011

(30) Foreign Application Priority Data
Nov. 25, 2010 (JP) 2010-261898

(51) Int. Cl. G06F 19/00

(52) U.S. Cl. 702/65

(57) ABSTRACT

The wire verification method calculates Iavg/Irms values of a wire using a net list and wire capacitance/resistance information of a circuit to be verified, relaxes a specified Irms value when the calculated Iavg/Irms values of the wire exceed predetermined specified Iavg/Irms values, tightens the specified Iavg value according to the relaxed specified Irms value, verifies whether a wire life calculated using the predetermined specified Irms value and the relaxed specified Irms value satisfies a predetermined specified wire life value, and further verifies whether the calculated Iavg/Irms values of the wire respectively exceed the tightened specified Iavg value and the relaxed specified Irms value.

### INCORPORATION BY REFERENCE

This application is based upon and claims the benefit of priority from Japanese patent application No. 2010-261898, filed on Nov. 25, 2010, the disclosure of which is incorporated herein in its entirety by reference.

### BACKGROUND OF THE INVENTION

1. Technical Field

The present invention relates to a wire verification method, a wire verification apparatus and a wire verification program for a semiconductor integrated circuit, and, particularly, to a wire verification method, a wire verification apparatus and a wire verification program for verifying the electromigration reliability of wires.

2. Background Art

As the speed of LSI grows faster, the phenomenon of electromigration (which is also referred to hereinafter as EM) in wires inside LSI has become an issue. Electromigration in wires inside LSI is the phenomenon that electrons flowing through a wire gradually “displace” metal atoms in the wire away to cause a defect of metal atoms called a void to occur inside the wire. The average lifetime of a wire caused by the phenomenon of electromigration is commonly expressed by the Black's equation, and it is largely dependent on the type of metal atoms (wire material), the current density, and the temperature. Al (aluminum) has been a major wire material in LSI; however, as the process technology has progressed from the 150-nm to the 90-nm generation, degradation due to electromigration has become a significant problem. To address the problem, Al, the wire material used, has been replaced by Cu (copper), and the degradation of wires due to electromigration has been significantly reduced as a result.

Further, as wires become finer with the progress of the process technology, the on-current of a MOS transistor is increasing, and there is a significant increase in the current density in wires. Specifically, due to the synergistic effect of the increase in the on-current of a MOS transistor and the reduction of the cross-sectional area of a wire (the area is reduced to about half every generation), the current density per unit area of a wire increases several-fold every generation, which makes the problem of electromigration worse. Although a fundamental solution would be a review of the wire material like replacement of Al by Cu, any material superior to Cu in terms of performance and cost has not been found under the present conditions, and it will be necessary to make LSI design with Cu at least for several generations to come. In such circumstances, the electromigration reliability (margin) of wires is less than that in the former-generation process, and it cannot be denied that the electromigration problem is likely to occur in the field.

In view of the degradation due to electromigration described above, various testing techniques have been proposed for the purpose of evaluating the EM resistance of metal lines at the LSI product design phase. A basic idea is to conduct verification of the EM resistance using two rules as disclosed in “CMOS VLSI Design (Third Edition)”, Neil H. E. Weste, ISBN 0-321-26977-2, pp. 240-241.

First, the average lifetime of a wire is evaluated based on the Black's equation. Normally, the lifetime of a wire (ten years, for example) is defined in advance, and whether the wire can guarantee the lifetime is evaluated by measuring the average current value (hereinafter abbreviated as Iavg) flowing through the wire. Parameters for the wire life evaluation which is used in the Black's equation are the current density flowing through the wire, the activation energy, and the temperature. The upper temperature limit of the LSI is typically used as the temperature.

Second, the self-heating of a wire is evaluated. Thermal energy occurs when current flows through a conductor. The energy is called Joule heat, and a rise in the temperature of a wire can lead to electromigration. The self-heating is defined using the root-mean-square value (hereinafter abbreviated as Irms) of current flowing through a wire. A fixed value is typically used as disclosed in “CMOS VLSI Design (Third Edition)”, Neil H. E. Weste, ISBN 0-321-26977-2, p. 241.

Because of the electrical resistance of a wire, a certain degree of self-heating occurs no matter small the value of Irms is. Thus, the evaluation of the self-heating by Irms is to guarantee that the temperature rise (ΔT) of a wire due to current is a certain level or less. According to the Black's equation, the wire life decreases exponentially with the rise in temperature. Therefore, if the self-heating of a wire is so high that a deviation from the ambient temperature (i.e. the temperature input to the Black's equation) is large, the wire life cannot be correctly evaluated.

Further, a technique relating to wire layout and wire verification program in consideration of the self-heating of wires is disclosed in Japanese Unexamined Patent Application Publication No. 2010-114377. FIG. 3 is a flowchart illustrating a method of laying out wires for an integrated circuit according to the technique disclosed therein. First, power supply wires for supplying power supply voltage to each circuit block are laid out in Step S110. Because the power supply wires are generally laid out in a grid pattern, the laid-out power supply wires are referred to also as a power supply grid. Next, signal wires for reflecting logic and the like to be implemented are laid out in Step S111. After that, processing for suppressing the Joule heating is performed.

A power density Dp is calculated using the power to be consumed in all power supply wires and all signal wires and the area in Step S112. Then, based on the power density Dp calculated in Step S112, it is determined whether the expected temperature rise ΔT exceeds the allowable value in Step S113. When the allowable value ΔTₗᵢₘᵢₜ is exceeded, the layout performed in Steps S110 and S111 is modified in Step S114 to reduce the power density Dp. Steps S114, S112 and S113 are repeated and, when the temperature rise ΔT of the integrated circuit falls within the range of the allowable value ΔTₗᵢₘᵢₜ, the layout of wires for suppressing the Joule heating ends.

As described above, according to the technique disclosed in Japanese Unexamined Patent Application Publication No. 2010-114377, verification and layout are performed to satisfy the specified value for the self-heating of wires. The specified value for the self-heating is defined as a fixed value.

Further, a technique to precisely measure the wire life, the temperature and the current density and estimate the wire life with high accuracy is disclosed in Japanese Unexamined Patent Application Publication No. H6-295950. According to the technique disclosed therein, accelerated test is conducted by supplying current to wires of a semiconductor apparatus, and the wire life, the wire current density and the wire temperature are acquired by the measurement. Then, based on those values, the acceleration factor, the current density dependent factor and the activation energy, which are wire life dependent parameters, are obtained by numerical calculation using the nonlinear least-squares method. Then, the wire life dependent parameters are applied to an electromigration reliability evaluation formula for the wires of the semiconductor apparatus.

### SUMMARY

However, there are several problems with the electromigration verification techniques disclosed in Japanese Unexamined Patent Application Publications Nos. 2010-114377 and H6-295950.

In the technique disclosed in Japanese Unexamined Patent Application Publication No. 2010-114377, verification and layout are performed to satisfy the specified value for the self-heating of wires. At this time, the specified value for the self-heating is defined as a fixed value. However, in recent high-performance microprocessors, LSI is making the shift to finer patterns and to higher frequency operation at the same time, which means that both the decrease in the wire cross-sectional area and the increase in the current density are under way. Therefore, if the specified value for the self-heating is fixed, design constraints become more demanding.

Further, in the electromigration verification technique disclosed in Japanese Unexamined Patent Application Publication No. H6-295950, verification is performed for each wire with varied temperature tinder the conditions of constant current and further performed with varied current under the conditions of constant temperature. Therefore, if this verification technique is used for recent large-scale LSI, verification takes a long time.

In light of the above problems, an exemplary object of the invention is to provide a wire verification method, a wire verification apparatus and a wire verification program capable of verifying the electromigration reliability of wires at high speed and without imposing significant design constraints.

In a first exemplary aspect of the invention, a wire verification method includes calculating an average current value and a root-mean-square current value of a wire using a net list and wire capacitance and resistance information of a circuit to be verified, verifying whether the calculated average current value and the calculated root-mean-square current value of the wire respectively exceed a predetermined specified average current value and a predetermined specified root-mean-square current value, relaxing the specified root-mean-square current value when at least one of the calculated average current value and the calculated root-mean-square current value of the wire exceeds the predetermined specified value, tightening the specified average current value according to the relaxed specified root-mean-square current value, verifying whether a wire life calculated using the predetermined specified root-mean-square current value and the relaxed specified root-mean-square current value satisfies a predetermined specified wire life value, and further verifying whether the calculated average current value and the calculated root-mean-square current value of the wire respectively exceed the tightened specified average current value and the relaxed specified root-mean-square current value.

In a second exemplary aspect, a wire verification apparatus includes a calculation means for calculating an average current value and a root-mean-square current value of a wire using a net list and wire capacitance and resistance information of a circuit to be verified, a verification means for verifying whether the calculated average current value and the calculated root-mean-square current value of the wire respectively exceed a predetermined specified average current value and a predetermined specified root-mean-square current value, a relaxing means for relaxing the specified root-mean-square current value when at least one of the calculated average current value and the calculated root-mean-square current value of the wire exceeds the predetermined specified value, a tightening means for tightening the specified average current value according to the relaxed specified root-mean-square current value, and a wire life verification means for verifying whether a wire life calculated using the predetermined specified root-mean-square current value and the relaxed specified root-mean-square current value satisfies a predetermined specified wire life value, and the verification means further verifies whether the calculated average current value and the calculated root-mean-square current value of the wire respectively exceed the tightened specified average current value and the relaxed specified root-mean-square current value.

In a third exemplary aspect, a non-transitory computer readable medium stores a wire verification program for causing a computer to execute a process including calculating an average current value and a root-mean-square current value of a wire using a net list and wire capacitance and resistance information of a circuit to be verified, verifying whether the calculated average current value and the calculated root-mean-square current value of the wire respectively exceed a predetermined specified average current value and a predetermined specified root-mean-square current value, relaxing the specified root-mean-square current value when at least one of the calculated average current value and the calculated root-mean-square current value of the wire exceeds the predetermined specified value, tightening the specified average current value according to the relaxed specified root-mean-square current value, verifying whether a wire life calculated using the predetermined specified root-mean-square current value and the relaxed specified root-mean-square current value satisfies a predetermined specified wire life value, and further verifying whether the calculated average current value and the calculated root-mean-square current value of the wire respectively exceed the tightened specified average current value and the relaxed specified root-mean-square current value.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a flowchart illustrating a wire verification method according to an exemplary embodiment;

FIG. 2 is a block diagram showing a wire verification apparatus according to an exemplary embodiment; and

FIG. 3 is a flowchart illustrating a wire layout method for an integrated circuit disclosed in Japanese Unexamined Patent Application Publication No. 2010-114377.

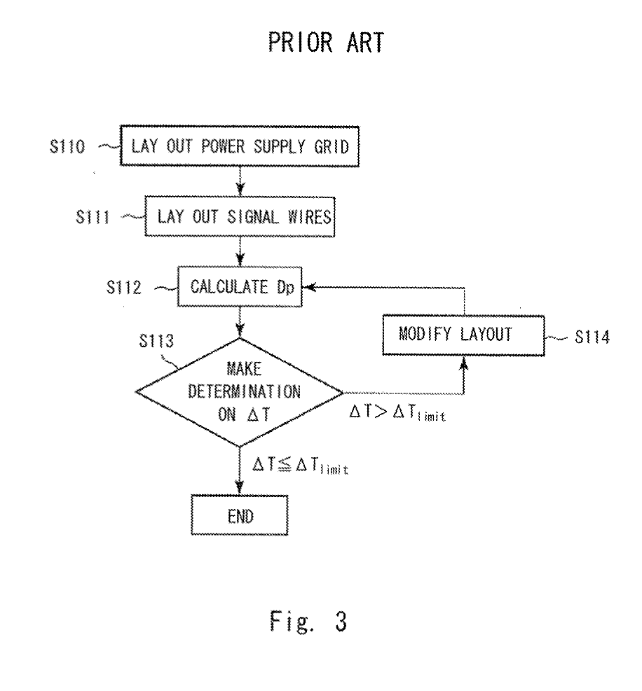

### EXEMPLARY EMBODIMENT

An exemplary embodiment of the invention is described hereinafter with reference to the drawings.

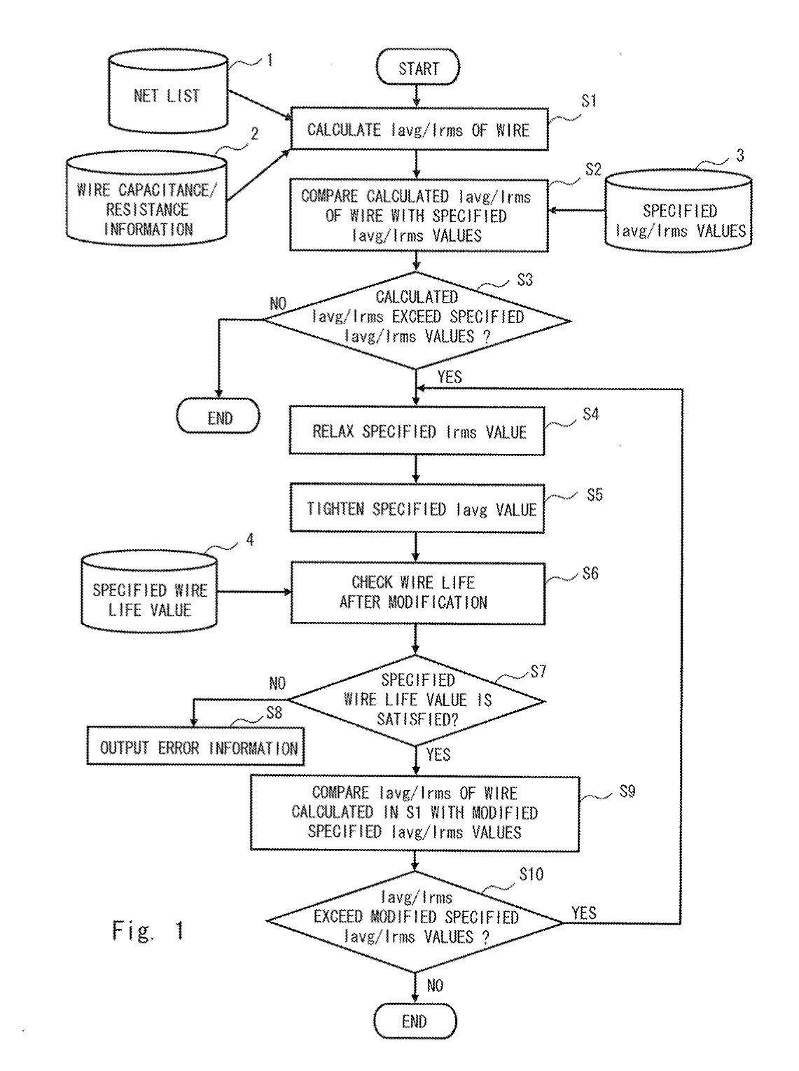

FIG. 1 is a flowchart illustrating a wire verification method for verifying the electromigration reliability of wires in a semiconductor integrated circuit according to the exemplary embodiment. In the wire verification method according to the exemplary embodiment, a net list (circuit description) 1, wire capacitance/resistance information (wire capacitance and resistance information) 2, specified values 3 for an average current value (Iavg) and a root-mean-square current value (Irms) which are specified for each cell (hereinafter referred to also as specified Iavg/Irms values), and a specified wire life value 4 are input. The net list 1, the wire capacitance/resistance information 2, the specified Iavg/Irms values 3 and the specified wire life value 4 are predetermined and stored in a memory of a computer, for example, prior to implementing the wire verification method according to the exemplary embodiment.

The net list 1 is circuit description describing connections between cells that constitute a logic circuit. The wire capacitance and resistance information 2 is information related to the capacitance value and the resistance value of each wire. The specified Iavg/Irms values 3 are the Iavg value and the Irms value which are allowed in a wire of a semiconductor integrated circuit to be verified. The specified wire life value 4 is the lifetime of a wire which is guaranteed in a semiconductor integrated circuit to be verified.

In the wire verification method according to the exemplary embodiment, the Iavg value and the Irms value of each wire are first calculated using the net list 1 and the wire capacitance/resistance information 2 of a circuit to be verified (Step S1).

Next, it is verified whether the Iavg value and the Irms value of the wire calculated in Step S1 respectively exceed the predetermined specified Iavg/Irms values 3. Specifically, the specified Iavg/Irms values 3 which are predetermined for each cell are read, and the specified Iavg/Irms values 3 are respectively compared with the Iavg value and the Irms value of the wire calculated in Step S1 (Step S2). Then, when the Iavg value and the Irms value of the wire calculated in Step S1 do not exceed the predetermined specified Iavg/Irms values 3, that is, when the Iavg value and the Irms value of the wire calculated in Step S1 are within the allowable range (No in Step S3), the wire verification ends, verifying that the electromigration reliability is satisfactory.

On the other hand, when at least one of the Iavg value and the Irms value of the wire calculated in Step S1 exceeds the predetermined specified Iavg/Irms values 3 (Yes in Step S3), the specified Irms value is relaxed (specifically, the specified Irms value is increased) (Step S4).

The Irms value is a parameter indicating the self-heating of a wire, and relaxing the value means allowing the self-heating of a wire, i.e., a rise in temperature. According to T. Chiang et al., “A New Analytical Thermal Model for ULSI Interconnects Incorporating Via Effect”, IEEE International Interconnect Technology Conference, pp. 92-94, 2001, the rise in temperature due to the self-heating of a wire is represented by the following equation.

$$\begin{matrix}Δ T = {Irms}^{2} \times \frac{electrical resistivity \times wire crosssectional area}{thermal conductivity of interlayer film \times factor} \\ = A \times {Irms}^{2}\end{matrix} \qquad ( 1 )$$

Thus, the temperature rise of a wire is proportional to the square of the Irms value. Therefore, when the specified Irms value before the relaxation is Irms0, the specified Irms value after the relaxation is Irms_miti, and the specified Irms value is relaxed to 1.4 times greater (Irms_miti=Irms0×1.4), the self-heating value ΔTmiti after the relaxation is represented by the following equation with respect to the self-heating ΔT0 of a wire defined by the specified Irms value.

Irms_miti=Irms0×1.4 (2)

ΔT0=A×Irms0² (3)

ΔTmiti=A×Irms_miti² (4)

From the equations (4) and (2),

$$\begin{matrix}Δ Tmiti = A \times {( Irms 0 \times 1.4 )}^{2} \\ \approx A \times Irms {0}^{2} \times 2\end{matrix} \qquad ( 5 )$$

Thus, from the equations (5) and (3),

ΔTmiti=ΔT0×2

Hence, if the specified Irms value is relaxed to 1.4 times greater, the self-heating of a wire becomes about 2 times higher. Although the case where the specified Irms value is relaxed to 1.4 times greater is described in the above example, the amount of relaxing the specified Irms value may be decided arbitrarily.

After relaxing the specified Irms value, the specified Iavg value is tightened (specifically, the specified Iavg value is decreased) (Step S5). The tightening of the specified Iavg value is imposed using the self-heating value obtained when relaxing the specified Irms value in Step S4 (which is calculated using the equation (1)). The Black's equation is represented as follows. Note that L is the lifetime of the wire, B is a constant specific the wire, S is the cross-sectional area of the wire, n is a constant indicating the current density dependence, Ea is the activation energy, k is the Boltzmann's constant, and T is the absolute temperature of the wire.

$$L = \frac{B}{{( \frac{Iavg}{S} )}^{n}} \times exp ( \frac{Ea}{k \times T} ) \qquad ( 6 )$$

Because the temperature T increases by the amount of the self-heating ΔT(=ΔTmiti−ΔT0) as a result of relaxing the specified Irms value, the wire life after the relaxation of the specified Irms value becomes shorter. The rate of change of the wire life before and after the relaxation can be represented by the following equation. The following equation can be obtained by dividing the wire life after the relaxation which is obtained using the equation (6) by the wire life before the relaxation which is obtained using the equation (6). Note that C is a coefficient.

$$Rate of change of wire life = exp \{ C \times ( \frac{1}{T + Δ T} - \frac{1}{T} ) \} \qquad ( 7 )$$

In Step S5, the specified Iavg value is tightened in order to extend the wire life which has become shorter as a result of relaxing the specified Irms value in Step S4. Specifically, because the wire life can be extended by decreasing the value of Iavg in the equation (6), the specified Iavg value is set to be lower than the initial value.

An example of the tightening of the specified Iavg value is described. When L0 is the wire life before the relaxation, and Iavg0 is the specified Iavg value before the relaxation, the wire life L0 before the relaxation can be represented as follows from the equation (6).

$$L 0 = \frac{B}{{( \frac{Iavg 0}{S} )}^{n}} \times exp ( \frac{Ea}{k \times T} ) \qquad ( 8 )$$

Likewise, when L1 is the wire life after the relaxation, Iavg1 is the specified Iavg value after the relaxation, and ΔT is the self-heating value, the wire life L1 after the relaxation can be represented as follows from the equation (6).

$$L 1 = \frac{B}{{( \frac{Iavg 1}{S} )}^{n}} \times exp ( \frac{Ea}{k \times ( T + Δ T )} ) \qquad ( 9 )$$

If it is assumed that the wire life does not change before and after the relaxation of the specified Irms value, L0=L1, and the following equation can be derived using the equation (8) and the equation (9).

$$\frac{B}{{( \frac{Iavg 0}{S} )}^{n}} \times exp ( \frac{Ea}{k \times T} ) = \frac{B}{{( \frac{Iavg 1}{S} )}^{n}} \times exp ( \frac{Ea}{k \times ( T + Δ T )} ) \qquad ( 10 )$$

Accordingly, the following equation can be derived using the equation (10).

$${( \frac{Iavg 1}{Iavg 0} )}^{n} = exp \{ \frac{Ea}{k} \times ( \frac{1}{T + Δ T} - \frac{1}{T} ) \} \qquad ( 11 )$$

Therefore, by setting Iavg1 that satisfies the equation (11), the specified Iavg value can be tightened. The value of Iavg1 is less than the value of Iavg0. Note that a method for tightening the specified Iavg value described above is just an example, and the specified Iavg value may be tightened using another method.

Then, it is verified whether the wire life calculated from the specified Irms value relaxed in Step S4 (the modified specified Irms value) and the specified Iavg value tightened in Step S5 (the modified specified Iavg value) satisfies the predetermined specified wire life value 4 or not (Step S6). In other words, it is verified whether the wire life is satisfied even when the self-heating occurs due to relaxing the specified Irms value. For example, the wire life can be calculated by substituting the self-heating value calculated based on the relaxed specified Irms value into the Black's the equation (6), and it can be represented as the equation (9).

When the calculated wire life does not satisfy the predetermined specified wire life value 4 (No in Step S7), the verification process ends at this point, outputting error information (Step S8).

On the other hand, when the calculated wire life satisfies the predetermined specified wire life value 4 (Yes in Step S7), it is verified whether the Iavg value and the Irms value of the wire calculated in Step S1 respectively exceed the modified specified Iavg value and the modified specified Irms value.

When the Iavg value and the Irms value of the wire calculated in Step S1 do not exceed the modified specified Iavg value and the modified specified Irms value, respectively, that is, when the Iavg value and the Irms value of the wire calculated in Step S1 are within the allowable range (No in Step S10), the wire verification ends, verifying that the electromigration reliability is satisfactory.

On the other hand, when the Iavg value and the Irms value of the wire calculated in Step S1 exceed the modified specified Iavg value and the modified specified Irms value, respectively, that is, when the Iavg value and the Irms value of the wire calculated in Step S1 are outside the allowable range (Yes in Step S10), the relaxing of the specified Irms value (Step S4), the tightening of the specified Iavg value (Step S5), the checking of the wire life (Steps S6 and S7), and the checking of the Iavg value and the Irms value of the wire calculated in Step S1 (Steps S9 and S10) are repeated.

As described above, the wire verification method according to the exemplary embodiment modifies the specified Irms value and the specified Iavg value using the Black's the equation (6), and verifies whether the Iavg value and the Irms value of the wire calculated in Step S1 respectively exceed the modified specified Iavg value and the modified specified Irms value. At this time, the tightening is imposed on the specified Iavg value in Step S5 to make up for the relaxing of the specified Irms value in Step S4 allowing for the self-heating of the wire, thereby suppressing the degradation of the wire life as well as allowing for the self-heating of the wire.

In the wire verification method according to the exemplary embodiment, because the specified value for the self-heating can be varied, the significant increase in design constraints can be prevented. Further, because the relatively simple equation (1) and the Black's equation (6) are used when modifying the specified Irms value and the specified Iavg value, the wire verification can be done at high speed. Therefore, according to the exemplary embodiment, the wire verification method capable of verifying the electromigration reliability of wires at high speed and without imposing significant design constraints can be provided.

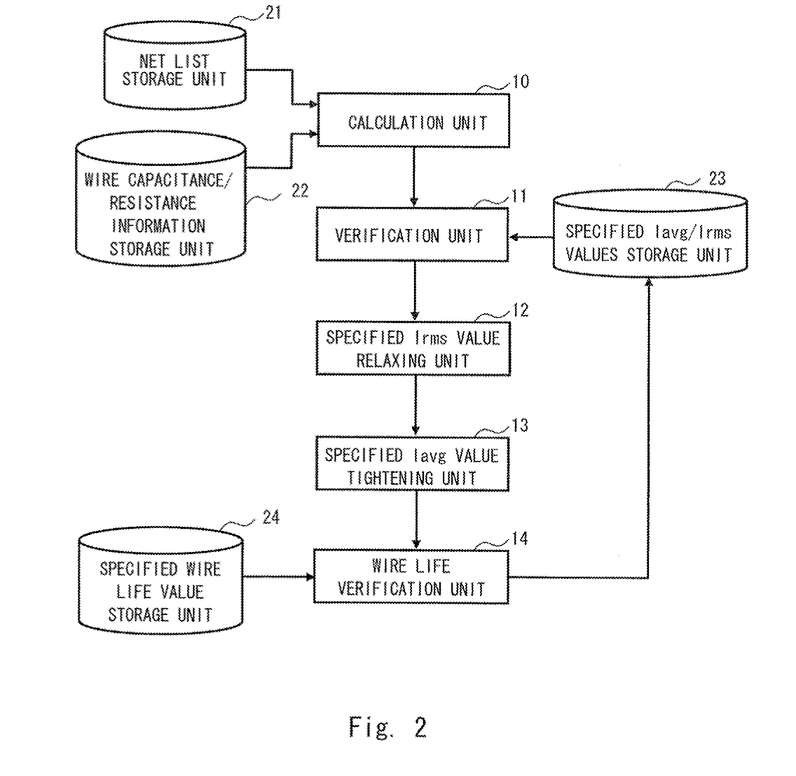

A wire verification apparatus according to the exemplary embodiment is described hereinbelow. FIG. 2 is a block diagram showing a wire verification apparatus according to the exemplary embodiment. The wire verification apparatus according to the exemplary embodiment is an apparatus capable of implementing the wire verification method illustrated in FIG. 1. The wire verification apparatus according to the exemplary embodiment includes a calculation unit 10, a verification unit 11, a specified Irms value relaxing unit 12, a specified Iavg value tightening unit 13, a wire life verification unit 14, a net list storage unit 21, a wire capacitance/resistance information storage unit 22, an specified Iavg/Irms values storage unit 23, and a specified wire life value storage unit 24.

The net list storage unit 21 stores circuit description describing connections between cells that constitute a logic circuit. The wire capacitance/resistance information storage unit 22 stores information related to the capacitance value and the resistance value of each wire. The specified Iavg/Irms values storage unit 23 stores the Iavg value and the Irms value that are allowed in a wire of a semiconductor integrated circuit to be verified. The specified wire life value storage unit 24 stores the lifetime of a wire that is guaranteed in a semiconductor integrated circuit to be verified.

The calculation unit 10 calculates the Iavg value and the Irms value of each wire using the net list supplied from the net list storage unit 21 and the wire capacitance/resistance information supplied from the wire capacitance/resistance information storage unit 22 (corresponding to Step S1 of FIG. 1).

The Iavg value and the Irms value of each wire calculated by the calculation unit 10 and the specified Iavg/Irms values stored in the specified Iavg/Irms values storage unit 23 are supplied to the verification unit 11. The verification unit 11 verifies whether the Iavg value and the Irms value of the wire calculated by the calculation unit 10 respectively exceed the predetermined specified Iavg/Irms values stored in the specified Iavg/Irms values storage unit 23. Specifically, the verification unit 11 reads the specified Iavg/Irms values predetermined for each cell, and compares the specified Iavg/Irms values respectively with the Iavg value and the Irms value of the wire calculated by the calculation unit 10 (corresponding to Step S2 of FIG. 1).

Then, when the Iavg value and the Irms value of the wire calculated by the calculation unit 10 do not exceed the specified Iavg/Irms values stored in the specified Iavg/Irms values storage unit 23, that is, when the Iavg value and the Irms value of the wire calculated by the calculation unit 10 are within the allowable range (corresponding to No in Step S3 of FIG. 1), the verification unit II ends the wire verification, verifying that the electromigration reliability is satisfactory.

On the other hand, when at least one of the Iavg value and the Irms value of the wire calculated by the calculation unit 10 exceeds the specified Iavg/Irms values stored in the specified Iavg/Irms values storage unit 23 (corresponding to Yes in Step S3 of FIG. 1), the verification unit 11 gives a notification to the specified Irms value relaxing unit 12.

When it is determined by the verification unit 11 that at least one of the Iavg value and the Irms value of the wire calculated by the calculation unit 10 exceeds the specified Iavg/Irms values stored in the specified Iavg/Irms values storage unit 23, the specified Irms value relaxing unit 12 relaxes the specified Irms value (corresponding to Step S4 of FIG. 1). Specifically, the specified Irms value relaxing unit 12 modifies the specified Irms value so that the specified Irms value becomes greater than the initial specified Irms value.

After the specified Irms value is relaxed by the specified Irms value relaxing unit 12, the specified Iavg value tightening unit 13 tightens the specified Iavg value (corresponding to Step S5 of FIG. 1). The tightening of the specified Iavg value is imposed using the self-heating value obtained when the specified Irms value is relaxed by the specified Irms value relaxing unit 12 (which is calculated using the equation (1)). The specified Iavg value tightening unit 13 tightens the specified Iavg value by recalculation using the Black's equation (6) described earlier in order to extend the wire life which has become shorter as a result of relaxing the specified Irms value by the specified Irms value relaxing unit 12. Specifically, because the wire life can be extended by decreasing the value of Iavg in the equation (6), the specified Iavg value is set to be lower than the initial value.

The wire life verification unit 14 receives input of the specified Irms value relaxed by the specified Irms value relaxing unit 12 (the modified specified Irms value) and the specified Iavg value tightened by the specified Iavg value tightening unit 13 (the modified specified Iavg value), and calculates the wire life from those values using the Black's equation (6). Then, the wire life verification unit 14 receives input of the specified wire life value stored in the specified wire life value storage unit 24, and verifies whether the calculated wire life satisfies the specified wire life value or not (corresponding to Step S6 of FIG. 1).

When the wire life verification unit 14 determines that the calculated wire life does not satisfy the specified wire life value stored in the specified wire life value storage unit 24 (corresponding to No in Step S7 of FIG. 1), the wire life verification unit 14 ends the verification process at this point, outputting error information.

On the other hand, when the wire life verification unit 14 determines that the calculated wire life satisfies the specified wire life value stored in the specified wire life value storage unit 24 (corresponding to Yes in Step S7 of FIG. 1), the wire life verification unit 14 writes the specified Irms value modified by the specified Irms value relaxing unit 12 and the specified Iavg value modified by the specified Iavg value tightening unit 13 over the specified Iavg/Irms values stored in the specified Iavg/Irms values storage unit 23.

The verification unit 11 verifies whether the Iavg value and the Irms value of the wire calculated by the calculation unit 10 respectively exceed the modified specified Iavg/Irms values stored in the specified Iavg/Irms values storage unit 23.

Then, when the Iavg value and the Irms value of the wire calculated by the calculation unit 10 respectively do not exceed the modified specified Iavg/Irms values stored in the specified Iavg/Irms values storage unit 23 (corresponding to No in Step S10 of FIG. 1), the verification unit 11 ends the wire verification, verifying that the electromigration reliability is satisfactory.

On the other hand, when the Iavg value and the Irms value of the wire calculated by the calculation unit 10 respectively exceed the modified specified Iavg/Irms values stored in the specified Iavg/Irms values storage unit 23 (corresponding to Yes in Step S10 of FIG. 1), the verification unit 11 repeats the relaxing of the specified Irms value in the specified Irms value relaxing unit 12, the tightening of the specified Iavg value in the specified Iavg value tightening unit 13, the verification of the calculated wire life in the wire life verification unit 14, and the verification of the Iavg value and the Irms value of the wire calculated by the calculation unit 10 in the verification unit 11.

As described above, the wire verification apparatus according to the exemplary embodiment modifies the specified Irms value and the specified Iavg value using the Black's the equation (6), and verifies whether the Iavg value and the Irms value of the wire calculated by the calculation unit 10 respectively exceed the modified specified Iavg value and the modified specified Irms value. At this time, the tightening is imposed on the specified Iavg value in the specified Iavg value tightening unit 13 to make up for the relaxing of the specified Irms value in the specified Irms value relaxing unit 12 allowing for the self-heating of the wire, thereby suppressing the degradation of the wire life as well as allowing for the self-heating of the wire.

In the wire verification apparatus according to the exemplary embodiment, because the specified value for the self-heating can be varied, the significant increase in design constraints can be prevented. Further, because the relatively simple equation (1) and the Black's equation (6) are used when modifying the specified Irms value and the specified Iavg value, the wire verification can be done at high speed. Therefore, according to the exemplary embodiment, the wire verification apparatus capable of verifying the electromigration reliability of wires at high speed and without imposing significant design constraints can be provided.

Although the example in which the wire verification apparatus is designed as hardware-based device is described in the above-described exemplary embodiment, the invention is not limited thereto. The invention may be implemented by a computer program running on a CPU (Central Processing Unit) to execute given processing. Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

For example, the wire verification apparatus according to the exemplary embodiment may be a computer device that includes a CPU for executing a program, ROM, RAM, and a hard disk storing a wire verification program causing the computer device to execute the above-described operation.

According to the exemplary embodiment described above, it is possible to provide a wire verification method, a wire verification apparatus and a wire verification program capable of verifying the electromigration reliability of wires at high speed and without imposing significant design constraints.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A wire verification method comprising:
calculating an average current value and a root-mean-square current value of a wire using a net list and wire capacitance and resistance information of a circuit to be verified;
verifying whether the calculated average current value and the calculated root-mean-square current value of the wire respectively exceed a predetermined specified average current value and a predetermined specified root-mean-square current value;
relaxing the specified root-mean-square current value when at least one of the calculated average current value and the calculated root-mean-square current value of the wire exceeds the predetermined specified value;
tightening the specified average current value according to the relaxed specified root-mean-square current value;
verifying whether a wire life calculated using the predetermined specified root-mean-square current value and the relaxed specified root-mean-square current value satisfies a predetermined specified wire life value; and
further verifying whether the calculated average current value and the calculated root-mean-square current value of the wire respectively exceed the tightened specified average current value and the relaxed specified root-mean-square current value.

2. The wire verification method according to claim 1, wherein the specified average current value is tightened according to a self-heating value obtained based on the relaxed specified root-mean-square current value.

3. The wire verification method according to claim 2, wherein the specified average current value is tightened so that a wire life calculated using the tightened specified average current value, the self-heating value and Black's equation satisfies the predetermined specified wire life value.

4. The wire verification method according to claim 2, wherein, when L0 is a wire life before the relaxing of the specified root-mean-square current value, Iavg0 is the specified average current value before the relaxing, L1 is a wire life after the relaxing of the specified root-mean-square current value, Iavg1 is the specified average current value after the relaxing, and ΔT is the self-heating value, the specified average current value is tightened to satisfy a following equation:
$${( \frac{Iavg 1}{Iavg 0} )}^{n} = exp \{ \frac{Ea}{k} \times ( \frac{1}{T + Δ T} - \frac{1}{T} ) \}$$

5. The wire verification method according to claim 1, wherein the wire life is calculated by substituting a self-heating value calculated based on the relaxed specified root-mean-square current value into Black's equation.

6. The wire verification method according to claim 1, comprising:
further relaxing the relaxed specified root-mean-square current value and tightening the tightened specified average current value when at least one of the calculated average current value and the calculated root-mean-square current value of the wire respectively exceeds the tightened specified average current value and the relaxed specified root-mean-square current value.

7. A wire verification apparatus comprising:
a calculation means for calculating an average current value and a root-mean-square current value of a wire using a net list and wire capacitance and resistance information of a circuit to be verified;
a verification means for verifying whether the calculated average current value and the calculated root-mean-square current value of the wire respectively exceed a predetermined specified average current value and a predetermined specified root-mean-square current value;
a relaxing means for relaxing the specified root-mean-square current value when at least one of the calculated average current value and the calculated root-mean-square current value of the wire exceeds the predetermined specified value;
a tightening means for tightening the specified average current value according to the relaxed specified root-mean-square current value; and
a wire life verification means for verifying whether a wire life calculated using the predetermined specified root-mean-square current value and the relaxed specified root-mean-square current value satisfies a predetermined specified wire life value,
wherein the verification means further verifies whether the calculated average current value and the calculated root-mean-square current value of the wire respectively exceed the tightened specified average current value and the relaxed specified root-mean-square current value.

8. The wire verification apparatus according to claim 7, wherein the tightening means tightens the specified average current value based on a self-heating value obtained when the specified root-mean-square current value is relaxed.

9. The wire verification apparatus according to claim 8, wherein the tightening means tightens the specified average current value so that a wire life calculated using the tightened specified average current value, the self-heating value obtained when the specified root-mean-square current value is relaxed, and Black's equation satisfies the predetermined specified wire life value.

10. A non-transitory computer readable medium storing a wire verification program for causing a computer to execute a process comprising:
calculating an average current value and a root-mean-square current value of a wire using a net list and wire capacitance and resistance information of a circuit to be verified;
verifying whether the calculated average current value and the calculated root-mean-square current value of the wire respectively exceed a predetermined specified average current value and a predetermined specified root-mean-square current value;
relaxing the specified root-mean-square current value when at least one of the calculated average current value and the calculated root-mean-square current value of the wire exceeds the predetermined specified value;
tightening the specified average current value according to the relaxed specified root-mean-square current value;
verifying whether a wire life calculated using the predetermined specified root-mean-square current value and the relaxed specified root-mean-square current value satisfies a predetermined specified wire life value; and
further verifying whether the calculated average current value and the calculated root-mean-square current value of the wire respectively exceed the tightened specified average current value and the relaxed specified root-mean-square current value.
